(19) United States
(12) Patent Application Publication
(10) Pub. No.: US 2025/0326617 A1
(43) Pub. Date: Oct. 23, 2025

(54) APPARATUS AND METHOD CONFIGURED TO DETACH A CRAWLER FROM A SURFACE USING A WHEEL TILING MECHANISM

(71) Applicant: SAUDI ARABIAN OIL COMPANY, Dhahran (SA)

(72) Inventors: Ahmed Al Brahim, Thuwal (SA); Fadl Abdellatif, Thuwal (SA)

(73) Assignee: SAUDI ARABIAN OIL COMPANY, Dhahran (SA)

(21) Appl. No.: 18/642,426

(22) Filed: Apr. 22, 2024

(51) Int. Cl. B66F 9/065; B60B 19/00; B66F 9/18

(52) U.S. Cl. CPC B66F 9/065; B66F 9/18; B60B 19/006

(57) ABSTRACT

An apparatus and method detach a crawler having a magnetic wheel from a surface of a structure using a wheel tilting mechanism. A portion of the magnetic wheel magnetically adheres to the surface. The apparatus includes a platform engaging the crawler. Movement of a coupling member of the platform pivots or tilts an axle of the magnetic wheel to lift a portion of the wheel away from the surface, thereby reducing the magnetic adhesion of the wheel to the surface. Based on the reduced magnetic adhesion, the platform detaches the magnetic wheel from the surface, and detaches the crawler from the platform. The method implements operation of the apparatus.

### FIELD OF THE DISCLOSURE

The present disclosure relates generally to crawlers for inspecting structures, and, more particularly, to an apparatus and method configured to detach a crawler from a surface of a structure using a wheel tiling mechanism.

### BACKGROUND OF THE DISCLOSURE

Robots and other autonomous or semi-autonomous devices have been developed for the inspection, maintenance, and cleaning of various structures in diverse environments, such as oil and gas pipelines. Some robots are configured to fly towards, perch on, and inspect such structures. Other robots even carry and then deploy other robots, typically crawlers released from a primary vehicle capable of flight. By using crawlers moving along surfaces of structures, the range and capabilities of robot technology has significantly increased.

Robots including crawlers with magnetic wheels enable such devices to adhere to various ferromagnetic surfaces as well as to crawl and climb on the surfaces. However, in order to prevent such robots from becoming inadvertently disengaged or to slip from ferromagnetic surfaces, wheels with powerful magnets are employed to establish a magnetic coupling or adhesion between the wheels and the ferromagnetic surfaces. Although the inadvertent disengagement of robots from surfaces is addressed by using powerful magnets, removing robots equipped with such powerful magnets from ferromagnetic surfaces requires a large amount of force. Since robots are implemented using batteries and other limited and portable power sources, the necessary energy required to provide such a large amount of force to pry off and detach robots from a surface is prohibitive in relation to the limited power capacity of a robot.

### SUMMARY OF THE DISCLOSURE

According to an implementation consistent with the present disclosure, an apparatus and method are configured to detach a crawler from a surface of a structure using a wheel tiling mechanism, and to attach the crawler to the surface of the structure using a magnetic wheel magnetically coupled to the surface.

In an implementation, a crawler is configured to move along a surface of a structure. The crawler comprises a body, a wheel, and a side member. The body includes a first attachment member and a pivot point. The wheel has an axle and an outer surface having a magnetic component and configured to move adjacent to the surface, wherein the magnetic component establishes a magnetic adhesion of the wheel to the surface. The side member is coupled to the axle and pivotally coupled to the pivot point, with the side member including a second attachment member. Responsive to a device moving the second attachment member, the side member pivots about the pivot point to pivot the axle. Responsive to the pivoting of the axle, a portion of the outer surface pivots away from the surface, thereby reducing the magnetic adhesion of the wheel to the surface. Responsive to the device moving the first attachment member away from the surface, the device overcomes the reduced magnetic adhesion and detaches the wheel from the surface to allow removal of the crawler from the surface.

The first attachment member can be configured to removably mechanically couple to the device. Alternatively, the first attachment member can be configured to removably magnetically couple to the device. The second attachment member can be configured to removably mechanically couple to the device. The device can include an actuator coupled to the hook, and movement of the actuator moves the hook, thereby moving the second attachment. The second attachment member can be configured to slidably engage a slot of the device to removably mechanically couple the second attachment member to the device. The second attachment member can be configured to removably mechanically couple to a hook of the device, and movement of the hook can move the second attachment member, thereby pivoting the side member about the pivot point to pivot the axle.

The second attachment member can include a slot, wherein the hook can be configured to removably enter the slot, and wherein the movement of the hook in the slot can pivot the side member about the pivot point to pivot the axle. The second attachment member can be configured to removably magnetically couple to the device.

In another implementation, an apparatus comprises a platform and a crawler. The platform includes a first actuator and a second actuator. The crawler is configured to move along a surface of a structure. The crawler comprises a body, a wheel, and a side member. The body includes a first attachment member removably coupled to the first actuator, and a pivot point. The wheel has an axle and an outer surface having a magnetic component and configured to move adjacent to the surface, wherein the magnetic component establishes a magnetic adhesion of the wheel to the surface. The side member is coupled to the axle and is pivotally coupled to the pivot point. The side member includes a second attachment member removably coupled to the second actuator. Responsive to the second actuator moving the second attachment member, the side member pivots about the pivot point to pivot the axle. Responsive to the pivoting of the axle, a portion of the outer surface pivots away from the surface, thereby reducing the magnetic adhesion of the wheel to the surface. Responsive to the first actuator moving the first attachment member away from the surface, the platform overcomes the reduced magnetic adhesion and detaches the wheel from the surface to allow removal of the crawler from the surface.

The first attachment member can be configured to removably mechanically couple to the first actuator. Alternatively, the first attachment member can be configured to removably magnetically couple to the first actuator. The second attachment member can be configured to removably mechanically couple to the second actuator. The second actuator can include a hook configured to removably mechanically couple to the second actuator, and movement of the second actuator moves the hook, thereby moving the second attachment member. The platform can further include an adaptor having a slot, wherein the platform can be coupled to the second actuator, and wherein the second attachment member can be configured to slidably engage the slot to removably mechanically couple the second attachment member to the platform. The platform can further include an adaptor. The second attachment member can be configured to removably mechanically couple to a hook of the adaptor, and movement of the hook can move the second attachment member, thereby pivoting the side member about the pivot point to pivot the axle.

The second attachment member can include a slot. The hook can be configured to removably enter the slot, and the movement of the hook in the slot can pivot the side member about the pivot point to pivot the axle. The second attachment member can be configured to removably magnetically couple to the device.

In a further implementation, a method comprises moving a crawler along a surface of a structure, wherein the crawler includes a magnetic wheel magnetically adhering to the surface. The method also comprises removably engaging a first coupling member of the crawler with a first coupling member of the platform, removably engaging a second coupling member of the crawler with a second coupling member of the platform, moving the second coupling member of the crawler towards the platform, pivoting a magnetic wheel, and moving a portion of the magnetic wheel away from the surface, thereby reducing the magnetic adhesion of the magnetic wheel to the surface. The method can also include moving the first coupling member of the platform to move the crawler away from the surface having the reduced magnetic adhesion with the magnetic wheel, and moving the combination of the crawler and the platform away from the surface. Moving the second coupling member of the crawler towards the platform can include retracting an actuator coupled to the second coupling member of the crawler.

Any combinations of the various embodiments, implementations, and examples disclosed herein can be used in a further implementation, consistent with the disclosure. These and other aspects and features can be appreciated from the following description of certain implementations presented herein in accordance with the disclosure and the accompanying drawings and claims.

### BRIEF DESCRIPTION OF THE DRAWINGS

FIG. 1 is a top front side perspective view of an apparatus including a crawler and a platform, according to an implementation.

FIG. 2 is a side elevational view of the apparatus of FIG. 1 with the crawler approaching the platform.

FIG. 3 is a side elevational view of the apparatus of FIG. 1 with the crawler coupled to the platform.

FIG. 4 is a front elevational view of the apparatus of FIG. 1 with the platform using actuators to tilt the wheels of the crawler.

FIG. 5 is a front elevational view of the apparatus of FIG. 1 with the platform lifting the crawler from a surface of a structure.

FIG. 6 is a top front side perspective view of the apparatus of FIG. 1 with the apparatus and crawler moving away from the surface.

FIG. 7 is a top front side perspective view of an apparatus including a crawler and a platform, according to an alternative implementation.

FIG. 8 is a top front side perspective view of an apparatus including a crawler and a platform, according to another alternative implementation.

FIG. 9 is a side elevational view of the apparatus of FIG. 8 with the crawler approaching the platform.

FIG. 10 is a side elevational view of the apparatus of FIG. 8 with the crawler coupled to the platform.

FIG. 11 is a front elevational view of the apparatus of FIG. 10.

FIG. 12 is a front elevational view of the apparatus of FIG. 8 with hooks of the platform engaging arms of the crawler.

FIG. 13 is a top front side perspective view of the apparatus of FIG. 8 with the platform rotating the hooks to tilt the wheels of the crawler.

FIG. 14 is a top front side perspective view of the apparatus of FIG. 8 with the apparatus and crawler moving away from the surface.

FIG. 15 is a flowchart of operation of a crawler detaching from a surface, according to an implementation.

FIG. 16 is a flowchart of operation of a crawler attaching to a surface, according to another implementation.

It is noted that the drawings are illustrative and are not necessarily to scale.

### DETAILED DESCRIPTION OF CERTAIN EMBODIMENTS OF THE DISCLOSURE

Example embodiments and implementations consistent with the teachings included in the present disclosure are directed to an apparatus and method are configured to detach a crawler from a surface of a structure using a wheel tiling mechanism, and to attach the crawler to the surface of the structure using a magnetic wheel magnetically coupled to the surface.

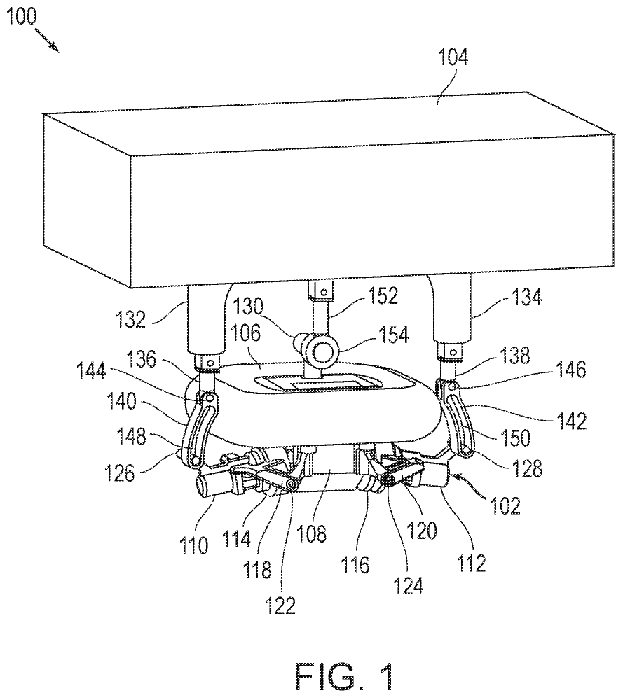

Referring to FIGS. 1-6, an apparatus 100 includes a crawler 102 and a platform 104, according to an implementation consistent with the present invention. The crawler 102 includes a body 106 and a sub-assembly 108. In one implementation, the sub-assembly 108 includes a probe configured to inspect the surface along which the crawler 102 moves. For example, the probe in the sub-assembly 108 is an ultrasound emitter and detector. In another example, the probe is an electromagnetic emitter and detector, such as camera with a light. The probe is configured to inspect the physical surface of the structure or to inspect the structure itself, for example, for cracks, rust, or other corrosion. In another implementation, the sub-assembly 108 includes any known payload included in or coupled to the crawler 102.

Referring to FIG. 1, the body 106 includes a housing having an interior to retain electronics. In one implementation, the crawler 102 includes a robot, a walker, or other known vehicles, such as described in U.S. Pat. No. 11,235,823, which is incorporated herein by reference in its entirety. In addition, the body 106 also includes a pair of side members 110, 112, with each side member 110, 112 rotatably coupled to an axle of a wheel 114, 116, respectively. Each wheel 114, 116 is configured to rotate about a respective axle. Each side member 110, 112 is attached to an arm 118, 120, respectively. In one implementation, the crawler 102 includes at least one wheel. In another implementation, the crawler 102 includes a pair of wheels 114, 116 disposed on opposite portions of the crawler 102, such as opposite sides of the crawler 102 as shown in FIG. 1. In a further implementation, the crawler 102 includes four wheels. In an implementation consistent with the invention, the wheels 114, 116 are composed of a magnetic material. In one implementation, at least the outer surfaces of the wheels 114, 116 are composed of magnetic material. For example, the wheels 114, 116 are permanent magnets. In another example, the wheels 114, 116 are electromagnets, with at least an electronic switch and a power source disposed in the body 106 to activate and deactivate the magnetism of each wheel 114, 116. In such examples, the magnetic wheels 114, 116 are configured to be magnetically attracted to magnetic structures. As described below, the crawler 102 with the magnetic wheels 114, 116 is configured to move along a surface of a structure. In one implementation, the surface includes a ferromagnetic composition, such as iron. In another implementation, the surface includes any known materials configured to be magnetically attracted and coupled to the magnetic wheels 114, 116. Such magnetic attraction between a surface and the wheels 114, 116 of the crawler 102 allows the crawler 102 to be removably held against the surface and to move adjacent to the surface, including curved surfaces, tilted surfaces, vertical surfaces, etc. without detaching.

A first assembly of the side member 110, the magnetic wheel 114, and the arm 118 is pivotally attached to the body 106 by a pivot point 122 as a first wheel rotation anchor. Similarly, a second assembly of the side member 112, the magnetic wheel 116, and the arm 120 is pivotally attached to the body 106 by a pivot point 124 as a second wheel rotation anchor. Accordingly, the first and second assemblies pivot about the pivot points 122, 124, respectively. In one implementation, each side member 110, 112 includes a pin 126, 128, respectively. In addition, a pin 130 is mounted to the body 106. For example, the pins 126, 128, 130 are non-magnetic. In another example, at least one of the pins 126, 128, 130 is magnetic.

In one implementation, the platform 104 includes a housing having an interior to retain electronics. For example, the platform 104 is a component of an unmanned robot, such as an unmanned aircraft vehicle (UAV), such as a drone or other known robotic devices, including a crawler, a roller, a walker, an autonomous underwater vehicle (AUV), etc., such as described in U.S. Pat. No. 11,235,823, incorporated above. In another example, the platform 104 is a component of a stationary docking system or a discrete moving vehicle.

Referring to FIG. 1, the platform 104 includes actuators 132, 134, with each actuator 132, 134 including a telescoping member 136, 138, respectively. Adaptors 140, 142 are pivotally coupled to an end of the telescoping member 136, 138, respectively, at a pivot 144, 146, respectively. Each adaptor 140, 142 includes an elongated slot 148, 150, respectively, configured to slidably engage a respective pin 126, 128. In one implementation, each pin 126, 128 has a circular cylindrical shape. As shown in FIG. 1, each of the adaptors 140, 142 has a curved profile, with the pins 126, 128 configured and dimensioned to removably engage and slide within the elongated slots 148, 150, respectively. In another example, the adaptors 140, 142 and elongated slots 148, 150 have a linear shape.

In one implementation, the platform 104 includes an actuator 152 having a retaining structure 154 configured to removably engage and mechanically couple with the pin 130. For example, the retaining structure 154 is configured as a ring or annulus. The pin 130 has a cross-section with a complementary shape, size, and dimension to removably engage and mechanically couple with the inner surface of the retaining structure 154. For example, the pin 130 has a circular cylindrical shape with a circular cross-section, and the retaining structure 154 is a circular ring or annulus configured to match the circular cylindrical shape of the pin 130. In another example, the pin 130 and the retaining structure 154 have any known complementary shapes, sizes, and dimensions. In another implementation, the pin 130 and the retaining structure 154 are magnetic with opposite polarities to attract each other by magnetic attraction, allowing the pin 130 and the retaining structure 154 to be magnetically coupled when in proximity to each other. In a further implementation, one of the pin 130 and the retaining structure 154 is a permanent magnet, and the other of the pin 130 and the retaining structure 154 is magnetically attracted to the permanent magnet. In an alternative embodiment, one of the pin 130 and the retaining structure 154 is an electromagnet controlled by electronics in the crawler 102 or the platform 104, respectively, and the other of the pin 130 and the retaining structure 154 is magnetically attracted to the electromagnet magnet. Such magnetic attraction of the pin 130 and the retaining structure 154 to be magnetically coupled enhances the mechanical coupling of the pin 130 with the retaining structure 154.

In an implementation, the actuators 132, 134, 152 are linear actuators configured to extend or retract in a linear direction in response to control signals from electronics included in the platform 104. In another implementation, the actuators 132, 134, 152 are any known actuator configured to move components of the crawler 102 toward or away from components of the platform 104. In a further implementation, the actuators 132, 134, 152 include motors such as servomotors configured to extend or retract a component such as the crawler 102 in any selected direction.

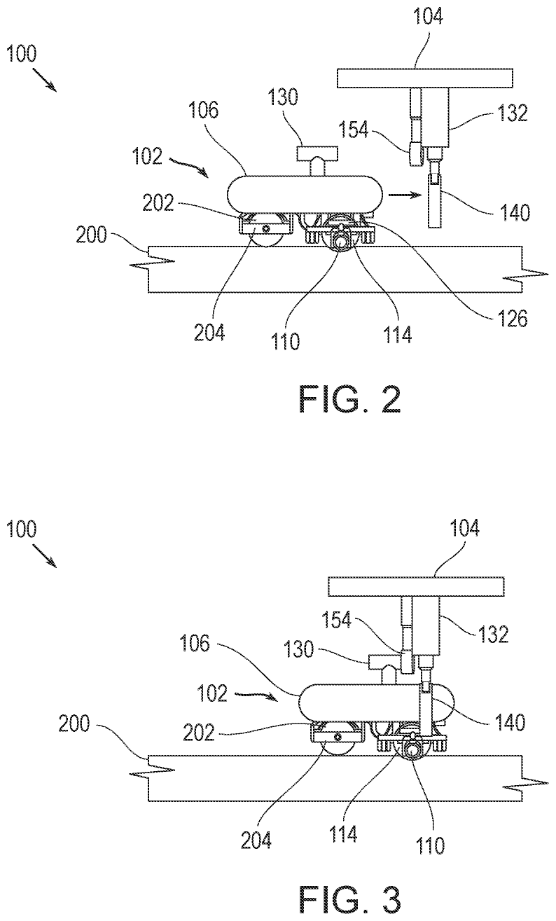

FIGS. 2-6 illustrate the process of detaching the crawler 102 from the surface 200 of the structure. As described above, the surface 200 includes a ferromagnetic composition, such as iron. In another implementation, the surface 200 includes any known materials configured to be magnetically attracted and coupled to the magnetic wheels 114, 116. As shown in FIG. 2, the crawler 102 approaches the platform 104, for example, from the left, as shown in the rightward arrow, with the crawler 102 magnetically coupled to the surface 200 of a structure by the magnetic wheels 114, 116. In one implementation, the crawler 102 also includes a drive wheel 202 rotatably mounted to a frame 204 attached to the body 106 of the crawler 102. Rotation of the drive wheel 202 clockwise or counterclockwise determines the direction parallel to the surface 200 in which the crawler 102 moves on the surface 200.

In one implementation, as the magnetic wheels 114, 116 are magnetically coupled to and moving along the surface 200, a contacting portion of each magnetic wheel 114, 116 is flush with the surface 200 due to the magnetic attraction between each of the magnetic wheels 114, 116 and the surface 200. For example, a portion of the surface 200 at the contact point of at least one magnetic wheel 114, 116 is planar. In another example, the portion of the surface 200 at the contact point of at least one magnetic wheel 114, 116 is curved. In a further example, one magnetic wheel 114 is magnetically coupled to a planar portion of the surface 200, while the other magnetic wheel 116 is magnetically coupled to a curved portion of the surface 200.

As shown in FIG. 3, the crawler 102 is positioned under the platform 104 such that the pin 130 moves into, engages, and removably couples with the retaining structure 154. In one implementation, a control system of the platform 104 is configured to control the actuators 132, 134, 152 to adjust and establish a height level for the retaining structure 152 and the adaptors 140, 142 with the slots 148, 150 to match an elevation of the pins 126, 128, 130, respectively. Once the heights and elevations of components are matched, the mechanical or magnetic coupling of components of the crawler 102 and the platform 104 is established.

In one implementation, the pin 130 and the retaining structure 154 are coupled by a friction fit. In another implementation, the retaining structure 154 includes a clamp or other known grasping mechanisms configured to mechanically and removably couple the pin 130 to the retaining structure 154.

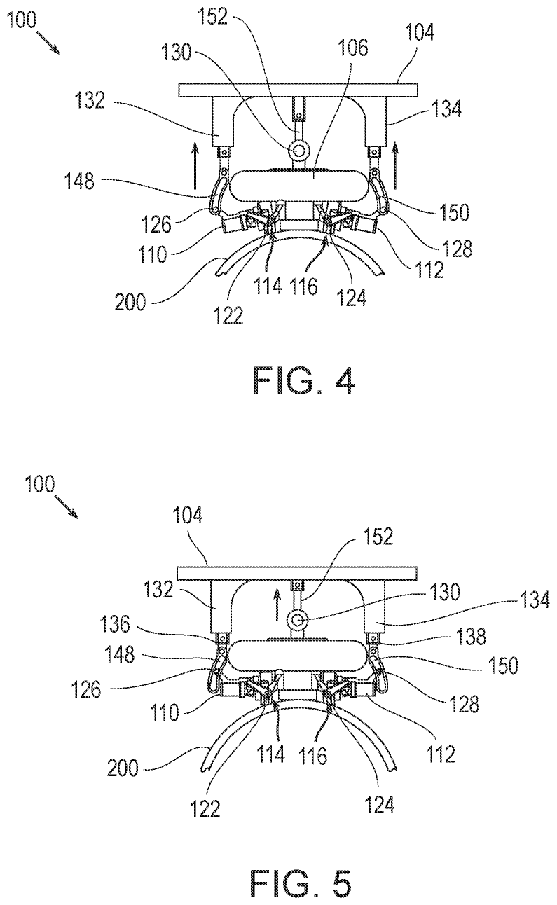

As shown in FIG. 4, as the crawler 102 is positioned under the platform 104, the pins 126, 128 move into, engage, and removably couple with the slots 148, 150, respectively. In one implementation, the pins 126, 128 are configured to slide within the slots 148, 150. The actuators 132, 134 then retract the telescoping members 136, 138, respectively, as shown in the upward arrows in FIG. 4. In turn, the adaptors 140, 142 also move upward to lift the pins 126, 128 upward as well. The lifting of the pins 126, 128 lifts the outward ends of the side members 110, 112, respectively, such that the side members 110, 112, the arms 118, 120, and the magnetic wheels 114, 116 rotate about the pivot points 122, 124, respectively.

In an implementation shown in FIGS. 1-6, the magnetic wheel 114 rotates in a clockwise direction about the pivot point 122, while the magnetic wheel 116 rotates in a counterclockwise direction about the pivot point 124. Such rotation of the magnetic wheels 114, 116 causes an outer portion of each wheel 114, 116 directed away from the center of the crawler 102 to move away from the surface 200. In an alternative implementation, the magnetic wheel 114 rotates in a first direction about the pivot point 122, while the magnetic wheel 116 rotates in a second direction about the pivot point 124. For example, the first and second directions of rotation are opposite angular directions. In another example, the first and second directions of rotation are in the same angular direction. In a further implementation, only one of the magnetic wheels 114, 116 is rotated to have a portion of the rotated magnetic wheel 114, 116 move away from the surface 200.

Any rotation of the magnetic wheels 114, 116 about the pivot points 122, 124, respectively, causes a portion of the rotated magnetic wheels 114, 116 to move away from the surface 200. In one implementation, as shown in FIGS. 4-5, an outer portion of each wheel 114, 116 directed away from the center of the crawler 102 to move away from the surface 200. Since the strength of magnetic attraction between the magnetic wheels 114, 116 and the surface 200 is inversely proportional to at least the distance between the magnetic wheels 114, 116 and the surface 200, the rotation of the wheels 114, 116 about the pivot points 122, 124, respectively, causes a reduction in the magnetic coupling or adhesion of the wheels 114, 116 with the surface 200. FIG. 5 illustrates the rotation of the side members 110, 112, the arms 118, 120, and the magnetic wheels 114, 116 about the pivot points 122, 124, respectively, from the configuration of such side members 110, 112, the arms 118, 120, and the magnetic wheels 114, 116 shown in FIG. 4. Accordingly, the configuration of the crawler 102 with rotated magnetic wheels 114, 116, as shown in FIG. 5, has a reduced magnetic coupling or adhesion of the crawler 102 to the surface 200, which facilitates removal of the crawler 102 from the surface 200.

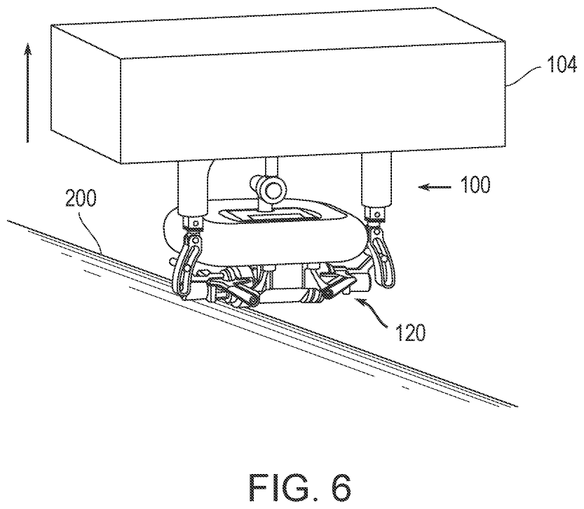

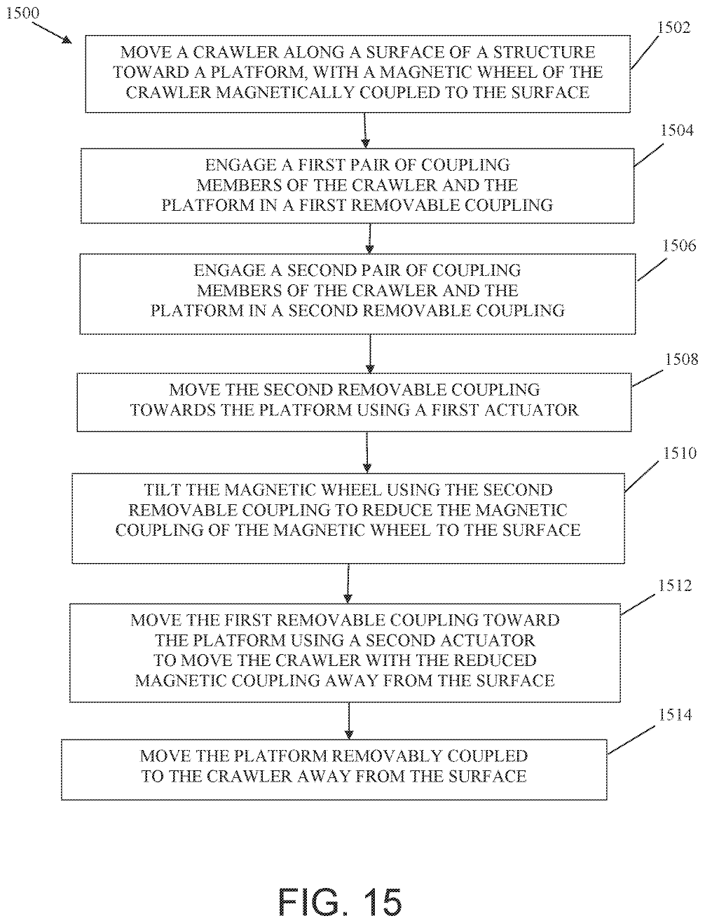

With the crawler 102 in such a configuration in FIG. 5, the actuator 152 lifts upward the retaining member 154 mechanically coupled to the pin 130, as shown by the upward arrow in FIG. 5, to further weaken the magnetic coupling or adhesion of the wheels 114, 116 and the surface 200. Since the rotated magnetic wheels 114, 116 have a reduced magnetic coupling or adhesion with the surface 200, the entire crawler 102 is readily detached from and lifted away from the surface 200 by the platform 104, as shown in FIG. 6. In an implementation, the apparatus 100 with at least the platform 104 is a UAV, allowing the apparatus 100 with the crawler 102, detached from the surface 200, to fly away from the surface 200. The steps illustrated in FIGS. 2-6 and as described above are further described below in conjunction with the method 1500 having the steps of the flowchart illustrated in FIG. 15.

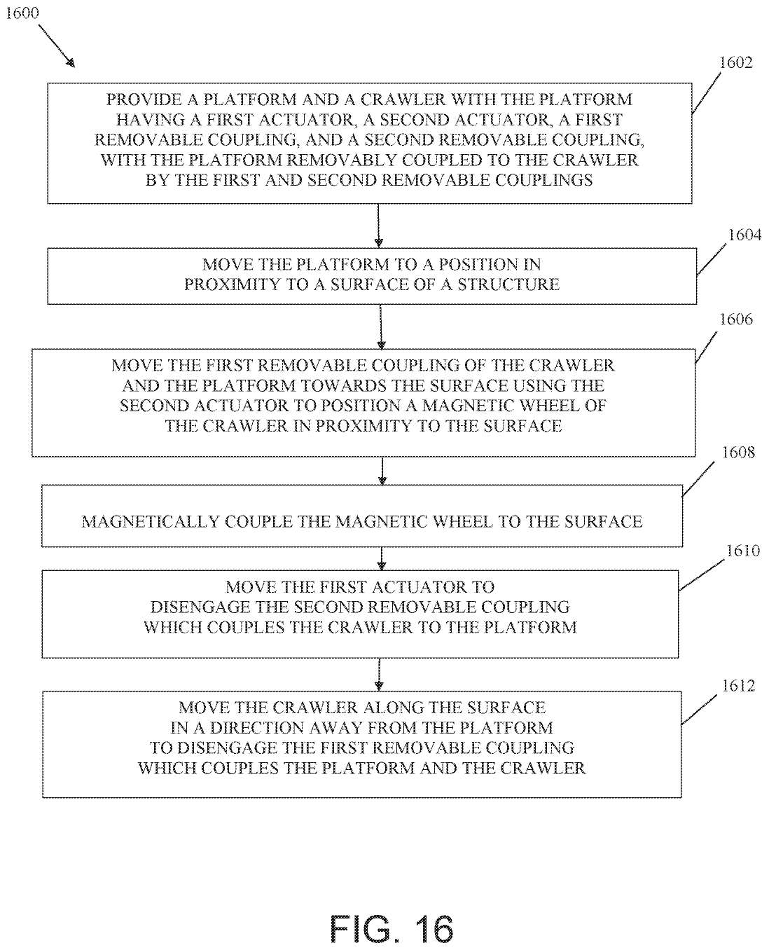

It is to be understood that the steps of detaching the crawler 102 from the surface 200 and attaching the crawler 102 to the platform 104 shown in FIGS. 2-6 are reversible to attach the crawler 102 to the surface 200 and to detach the crawler 102 from the platform 104. That is, the illustrated steps described above, proceeding from the configuration of the apparatus 100 and the surface 200 in FIG. 6 to the configuration of the apparatus 100 and the surface 200 in FIG. 2 are performed to attach the crawler 102 to the surface 200 and to detach the crawler 102 to the platform 104. The reverse progression of the steps illustrated in FIGS. 2-6 and as described above are further described below in conjunction with the method 1600 having the steps of the flowchart illustrated in FIG. 16.

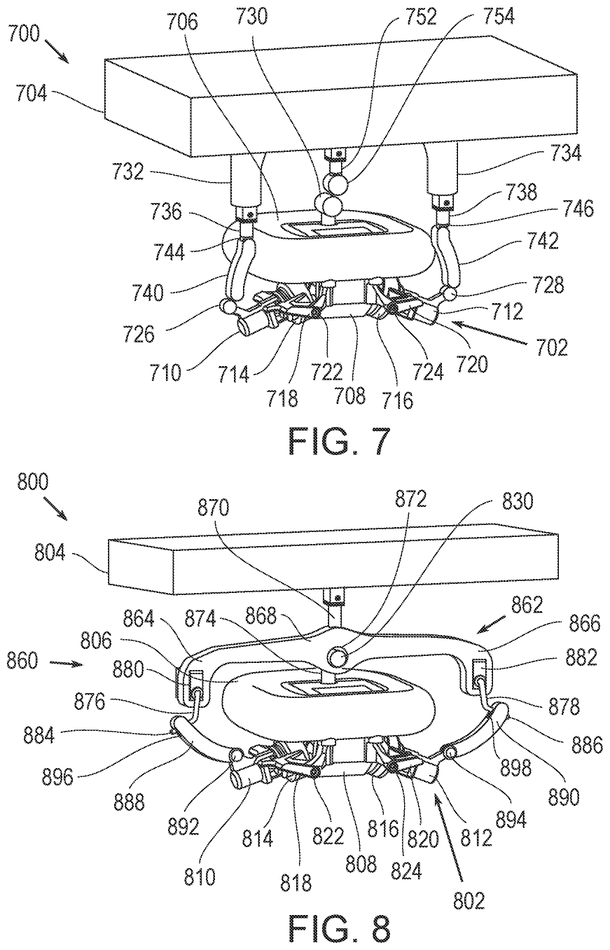

In an alternative implementation shown in FIG. 7, consistent with the present invention, the apparatus 700 includes a magnetic coupling or adhesion of components of the crawler 702 with the components of the platform 704, instead of the mechanical coupling of components of the crawler 102 with the components of the platform 104 of the apparatus 100 as illustrated and described above with reference to FIGS. 1-6.

As shown in FIG. 7, the crawler 702 includes a body 706 and a sub-assembly 708. In one implementation, the sub-assembly 708 includes a probe configured to inspect the surface along which the crawler 702 moves. For example, the probe in the sub-assembly 708 is an ultrasound emitter and detector. In another example, the probe is an electromagnetic emitter and detector, such as camera with a light. The probe is configured to inspect the physical surface of the structure or to inspect the structure itself, for example, for cracks, rust, or other corrosion. In another implementation, the sub-assembly 708 includes any known payload included in or coupled to the crawler 702.

Referring to FIG. 7, the body 706 includes a housing having an interior to retain electronics. In one implementation, the crawler 702 includes a robot, a walker, or other known vehicles, such as described in U.S. Pat. No. 11,235,823, incorporated above. In addition, the body 706 also includes a pair of side members 710, 712, with each side member 710, 712 rotatably coupled to an axle of a wheel 714, 716, respectively. Each side member 710, 712 is attached to an arm 718, 720, respectively. In one implementation, the crawler 702 includes at least one wheel. In another implementation, the crawler 702 includes a pair of wheels 714, 716 disposed on opposite portions of the crawler 702, such as opposite sides of the crawler 702 as shown in FIG. 7. In a further implementation, the crawler 702 includes four wheels. In an implementation consistent with the invention, the wheels 714, 716 are composed of a magnetic material. In one implementation, at least the outer surfaces of the wheels 714, 716 are composed of magnetic material. For example, the wheels 714, 716 are permanent magnets. In another example, the wheels 714, 716 are electromagnets, with at least an electronic switch and a power source disposed in the body 706 to activate and deactivate the magnetism of each wheel 714, 716. In such examples, the magnetic wheels 714, 716 are configured to be magnetically attracted to magnetic structures. As described below, the crawler 702 with the magnetic wheels 714, 716 is configured to move along a surface of a structure. In one implementation, the surface includes a ferromagnetic composition, such as iron. In another implementation, the surface includes any known materials configured to be magnetically attracted and coupled to the magnetic wheels 714, 716. Such magnetic attraction between a surface and the wheels 714, 716 of the crawler 702 allows the crawler 702 to be removably held against the surface and to move adjacent to the surface, including curved surfaces, tilted surfaces, vertical surfaces, etc. without detaching.

A first assembly of the side member 710, the magnetic wheel 714, and the arm 718 is pivotally attached to the body 706 by a pivot point 722 as a first wheel rotation anchor. Similarly, a second assembly of the side member 712, the magnetic wheel 716, and the arm 720 is pivotally attached to the body 706 by a pivot point 724 as a second wheel rotation anchor. Accordingly, the first and second assemblies pivot about the pivot points 722, 724, respectively. In one implementation, each side member 710, 712 includes a magnetic pin 726, 728, respectively. In addition, a magnetic pin 730 is mounted to the body 706.

In one implementation, the platform 704 includes a housing having an interior to retain electronics. For example, the platform 704 is a component of an unmanned robot, such as an unmanned aircraft vehicle (UAV), such as a drone or other known robotic devices, including a crawler, a roller, a walker, an autonomous underwater vehicle (AUV), etc., such as described in U.S. Pat. No. 11,235,823, incorporated above. Referring to FIG. 7, the platform 704 includes actuators 732, 734, with each actuator 732, 734 including a telescoping member 736, 738, respectively. Adaptors 740, 742 are pivotally coupled to an end of the telescoping member 736, 738, respectively, at a pivot 744, 746, respectively. Each adaptor 140, 142 is an elongated member with at least a lower portion of each adaptor 740, 742 being magnetically attracted to the magnetic pin 726, 728, respectively. In another implementation, the pins 726, 728 and the lower portion of each adaptor 740, 742 are magnetic with opposite polarities to attract each other by magnetic attraction, allowing the pins 726, 728 and the lower portion of the adaptors 740, 742, respectively, to be magnetically coupled when in proximity to each other. In a further implementation, one of the pin 726, 728 and a corresponding lower portion of the adaptor 740, 742, respectively, is a permanent magnet, and the other of the pin 726, 728 and the corresponding lower portion of the adaptor 740, 742 is magnetically attracted to the permanent magnet. In an alternative embodiment, one of the pin 726, 728 and the corresponding lower portion of the adaptor 740, 742, respectively, is an electromagnet controlled by electronics in the crawler 702 or the platform 704, respectively, and the other of the pin 726, 728 and the corresponding lower portion of the adaptor 740, 742 is magnetically attracted to the electromagnet magnet.

In one implementation, each magnetic pin 726, 728 has a circular cylindrical shape, as shown in FIG. 7. In another implementation, each magnetic pin 726, 728 has any shape, with at least a top portion of the magnetic pin 726, 728 being magnetic to magnetically couple with the corresponding lower portion of the adaptor 740, 742. As shown in FIG. 7, in one implementation, each of the adaptors 740, 742 has a curved shape, with at least a lower portion of the adaptor 740, 742 being magnetic or being magnetically attracted to the corresponding magnetic pin 726, 728, respectively. In another implementation, each of the adaptors 740, 742 has any shape, with at least a lower portion of the adaptor 740, 742 being magnetic or being magnetically attracted to the corresponding magnetic pin 726, 728, respectively.

In one implementation, the platform 704 includes an actuator 752 having a coupling member 754 configured to removably engage and magnetically couple with the magnetic pin 730. In an implementation, the actuators 732, 734, 752 are linear actuators configured to extend or retract in a linear direction in response to control signals from electronics included in the platform 704. In another implementation, the actuators 732, 734, 752 are any known actuator configured to move components of the crawler 702 toward or away from components of the platform 704.

In operation, the apparatus 700 shown in FIG. 7 performs in the same manner shown in FIGS. 2-6 to detach the crawler 702 from a surface to which magnet wheels 714, 716 are magnetically attached. As in FIG. 2, the crawler 702 approaches the platform 704. Similar to the configuration in FIG. 3, the magnetic pin 730 of the crawler 702 magnetically couples or adheres to the coupling member 754 of the platform 704 to magnetically engage the crawler 702 to the platform 704. Similar to the configuration in FIG. 4, the magnetic pins 726, 728 become magnetically coupled to at least the lower portion of the corresponding adaptors 740, 742, and then the actuators 732, 734 lift the adaptors 740, 742 and their corresponding magnetic pins 726, 728. Such movement of the magnetic pins 726, 728 rotates the magnetic wheels 714, 716, respectively about the pivot points 722, 724, respectively, and the magnetic wheels 714, 716 tilt in a manner similar to the tilting of the magnetic wheels 114, 116 in FIG. 5. Such tilting of the magnetic wheels 714, 716 reduces the magnetic attraction of the magnetic wheels 714, 716 to the surface. The reduced magnetic attraction allows the crawler 702 with the magnetic wheels 714, 716 detach from the surface. Then the platform 704 lifts the crawler 702 with the reduced magnetic attraction away from the surface, similar to the configuration of the platform 104 and the crawler 102 in FIG. 6. The steps illustrated in FIGS. 2-6 in conjunction and as described above in conjunction with the implementation of the apparatus 700 in FIG. 7 are further described below in conjunction with the method 1500 having the steps of the flowchart illustrated in FIG. 15.

It is to be understood that the steps of detaching the crawler 702 from the surface 200 and attaching the crawler 702 to the platform 704 in a similar manner as shown in FIGS. 2-6 are reversible to attach the crawler 702 to the surface 200 and to detach the crawler 702 from the platform 704. That is, proceeding from the configuration of the apparatus 700 detached from a surface 200, in a manner similar to FIG. 6, to the configuration of the apparatus 700 and the surface 200 in a manner similar to FIG. 2 are performed to attach the crawler 702 to the surface 200 and to detach the crawler 702 to the platform 704. The reverse progression of the steps illustrated in FIGS. 2-6 and as described above in conjunction with the implementation of the apparatus 700 in FIG. 7 are further described below in conjunction with the method 1600 having the steps of the flowchart illustrated in FIG. 16.

In another alternative implementation shown in FIGS. 8-14, consistent with the present invention, an apparatus 800 includes a crawler 802 and a platform 804. The crawler 802 includes a body 806 and a sub-assembly 808. In one implementation, the sub-assembly 808 includes a probe configured to inspect the surface along which the crawler 802 moves. For example, the probe in the sub-assembly 808 is an ultrasound emitter and detector. In another example, the probe is an electromagnetic emitter and detector, such as camera with a light. The probe is configured to inspect the physical surface of the structure or to inspect the structure itself, for example, for cracks, rust, or other corrosion. In another implementation, the sub-assembly 808 includes any known payload included in or coupled to the crawler 802.

Referring to FIG. 8, the body 806 includes a housing having an interior to retain electronics. In one implementation, the crawler 802 includes a robot, a walker, or other known vehicles, such as described in U.S. Pat. No. 11,235,823, incorporated above. In addition, the body 806 also includes a pair of side members 810, 812, with each side member 810, 812 rotatably coupled to an axle of a wheel 814, 816, respectively. Each side member 810, 812 is attached to an arm 818, 820, respectively. In one implementation, the crawler 802 includes at least one wheel. In another implementation, the crawler 802 includes a pair of wheels 814, 816 disposed on opposite portions of the crawler 802, such as opposite sides of the crawler 802 as shown in FIG. 8. In a further implementation, the crawler 802 includes four wheels. In an implementation consistent with the invention, the wheels 814, 816 are composed of a magnetic material. In one implementation, at least the outer surfaces of the wheels 814, 816 are composed of magnetic material. For example, the wheels 814, 816 are permanent magnets. In another example, the wheels 814, 816 are electromagnets, with at least an electronic switch and a power source disposed in the body 806 to activate and deactivate the magnetism of each wheel 814, 816. In such examples, the magnetic wheels 814, 816 are configured to be magnetically attracted to magnetic structures. As described below, the crawler 802 with the magnetic wheels 814, 816 is configured to move along a surface of a structure. In one implementation, the surface includes a ferromagnetic composition, such as iron. In another implementation, the surface includes any known materials configured to be magnetically attracted and coupled to the magnetic wheels 814, 816. Such magnetic attraction between a surface and the wheels 814, 816 of the crawler 802 allows the crawler 802 to be removably held against the surface and to move adjacent to the surface, including curved surfaces, tilted surfaces, vertical surfaces, etc. without detaching.

As shown in FIG. 8, in one implementation, a first assembly of the side member 810, the magnetic wheel 814, and the arm 818 is pivotally attached to the body 806 by a pivot point 822 as a first wheel rotation anchor. Similarly, a second assembly of the side member 812, the magnetic wheel 816, and the arm 820 is pivotally attached to the body 806 by a pivot point 824 as a second wheel rotation anchor. Accordingly, the first and second assemblies pivot about the pivot points 822, 824, respectively. In one implementation, each side member 810, 812 is attached to an adaptor 888, 890, respectively, at a pivot point 892, 894, respectively. Each adaptor 888, 890 includes an elongated slot 896, 898, respectively.

In one implementation, the platform 804 includes a housing having an interior to retain electronics. For example, the platform 804 is a component of an unmanned robot, such as an unmanned aircraft vehicle (UAV), such as a drone or other known robotic devices, including a crawler, a roller, a walker, an autonomous underwater vehicle (AUV), etc., such as described in U.S. Pat. No. 11,235,823, incorporated above. Referring to FIG. 8, the platform 804 includes an elongated member 860 having a yoke 862 with arms 864, 866 extending from a central portion 868. The platform 804 also includes an actuator 870 having a telescoping member attached to the yoke 862 at the central portion 868. The central portion 868 includes an aperture 872 therethrough.

The crawler 802 includes a pin 830 attached to a mounting member 874 mounted on the body 806. The pin 830 is configured, sized, and dimensioned to be removably retained in the aperture 872. For example, the pin 830 has a circular cylindrical shape extending from the mounting member 874, and the cross-sectional shape of the pin 830 has a diameter less than the diameter of the aperture 872 to removably engage and mechanically couple with the aperture 872. In one implementation, as shown in FIG. 8, the pin 830 is held in the aperture 872 by gravity. In another implementation, the pin 830 has a cross-sectional shape matching the shape of the aperture 872, and the pin 830 is removably retained in the aperture 872 by a friction fit.

In one implementation, the elongated member 860 includes hooks 876, 878 having ends 884, 886, respectively, with each hook 876, 878 rotatable about a shaft of a motor 880, 882, respectively, mounted on the end of the arm 864, 866. Each of the ends 884, 886 of the hooks 876, 878, respectively, is configured, sized, and dimensioned to fit and extend through the slots 896, 898, respectively, of the adaptors 888, 890, respectively. In one implementation, as described below, each hook 876, 878 is rotated by the motors 880, 882, respectively, such that the ends 884, 886 pass through and extend through the slots 896, 898, respectively.

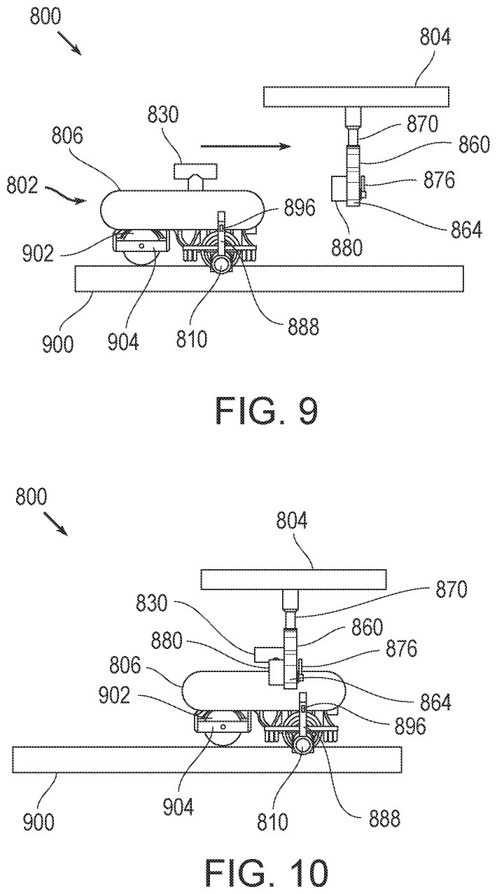

FIGS. 9-14 illustrate the process of detaching the crawler 802 from the surface 900 of the structure. As described above with regard to surface 200, the surface 900 includes a ferromagnetic composition, such as iron. In another implementation, the surface 900 includes any known materials configured to be magnetically attracted and coupled to the magnetic wheels 814, 816. As shown in FIG. 9, the crawler 802 approaches the platform 804, for example, from the left, as shown in the rightward arrow, with the crawler 802 magnetically coupled to the surface 900 of a structure by the magnetic wheels 814, 816. In one implementation, the crawler 802 also includes a drive wheel 902 rotatably mounted to a frame 904 attached to the body 806 of the crawler 802. Rotation of the drive wheel 902 clockwise or counterclockwise determines the direction parallel to the surface 900 in which the crawler 802 moves on the surface 900.

In one implementation, as the magnetic wheels 814, 816 are magnetically coupled to and moving along the surface 900, a contacting portion of each magnetic wheel 814, 816 is flush with the surface 900 due to the magnetic attraction between each of the magnetic wheels 814, 816 and the surface 900. For example, a portion of the surface 900 at the contact point of at least one magnetic wheel 814, 816 is planar. In another example, the portion of the surface 900 at the contact point of at least one magnetic wheel 814, 816 is curved. In a further example, one magnetic wheel 814 is magnetically coupled to a planar portion of the surface 900, while the other magnetic wheel 816 is magnetically coupled to a curved portion of the surface 900.

As shown in FIG. 10, the crawler 802 is positioned under the platform 804 such that the pin 830 moves into, engages, and removably couples with the aperture 872. In one implementation, the pin 830 and the aperture 872 are coupled by a friction fit. In another implementation, the central portion 868 includes a clamp or other known grasping mechanisms configured to mechanically and removably couple the pin 830 to the aperture 872.

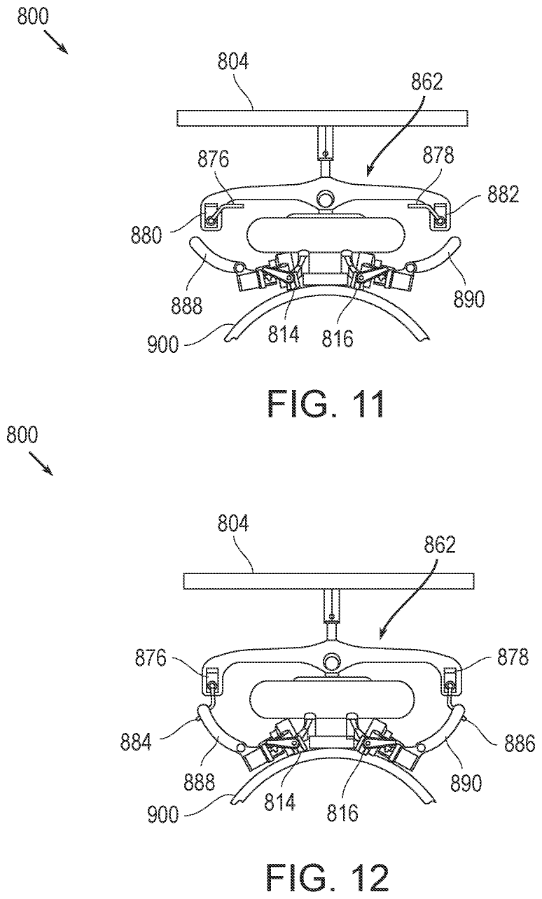

As shown in FIG. 11, as the crawler 802 is positioned under the platform 804, the motors 880, 882 rotate the hooks 876, 878, respectively, to move into, engage, and removably couple with the slots 896, 898, respectively, of the adaptors 888, 890, respectively. In one implementation, the hooks 876, 878 are configured to slide within the slots 896, 898, as shown in FIG. 12. Further rotation of the hooks 876, 878 by the motors 880, 882, respectively, lift the ends of the adaptors 888, 890, respectively, and rotate the adaptors 888, 890 about the pivot points 892, 894, respectively, as shown in FIG. 12. The lifting of the adaptors 888, 890 lifts the outward ends of the side members 810, 812, respectively, such that the side members 810, 812, the arms 818, 820, and the magnetic wheels 814, 816 rotate about the pivot points 822, 824, respectively.

In an implementation shown in FIGS. 8-14, the magnetic wheel 814 rotates in a clockwise direction about the pivot point 822, while the magnetic wheel 816 rotates in a counterclockwise direction about the pivot point 824. Such rotation of the magnetic wheels 814, 816 causes an outer portion of each wheel 814, 816 directed away from the center of the crawler 802 to move away from the surface 900. In an alternative implementation, the magnetic wheel 814 rotates in a first direction about the pivot point 822, while the magnetic wheel 816 rotates in a second direction about the pivot point 824. For example, the first and second directions of rotation are opposite angular directions. In another example, the first and second directions of rotation are in the same angular direction. In a further implementation, only one of the magnetic wheels 814, 816 is rotated to have a portion of the rotated magnetic wheel 814, 816 move away from the surface 900.

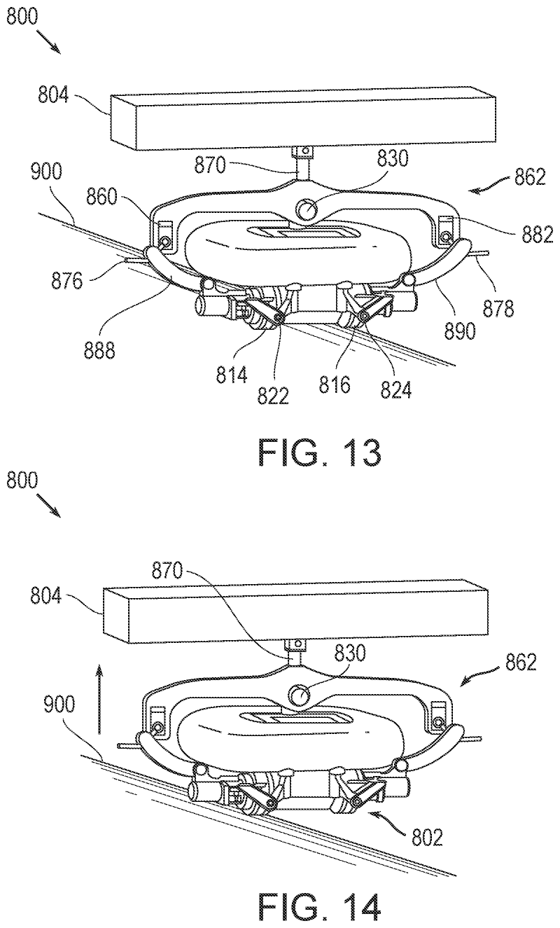

Any rotation of the magnetic wheels 814, 816 about the pivot points 822, 824, respectively, causes a portion of the rotated magnetic wheels 814, 816 to move away from the surface 900. In one implementation, as shown in FIGS. 12-13, an outer portion of each wheel 814, 816 directed away from the center of the crawler 802 to move away from the surface 900. Since the strength of magnetic attraction between the magnetic wheels 814, 816 and the surface 900 is inversely proportional to at least the distance between the magnetic wheels 814, 816 and the surface 900, the rotation of the wheels 814, 816 about the pivot points 822, 824, respectively, causes a reduction in the magnetic coupling or adhesion of the wheels 814, 816 with the surface 900. FIG. 13 illustrates the rotation of the side members 810, 812, the arms 818, 820, and the magnetic wheels 814, 816 about the pivot points 822, 824, respectively, from the configuration of such side members 810, 812, the arms 818, 820, and the magnetic wheels 814, 816 shown in FIG. 12. Accordingly, the configuration of the crawler 802 with rotated magnetic wheels 814, 816, as shown in FIG. 13, has a reduced magnetic coupling or adhesion of the crawler 802 to the surface 900, which facilitates removal of the crawler 802 from the surface 900.

With the crawler 802 in such a configuration in FIG. 13, the actuator 870 lifts upward the yoke 862 with the central portion 868 having the aperture 872 mechanically coupled to the pin 830, as shown by the upward arrow in FIG. 14, to further weaken the magnetic coupling or adhesion of the wheels 814, 816 and the surface 900. Since the rotated magnetic wheels 814, 816 have a reduced magnetic coupling or adhesion with the surface 900, the entire crawler 802 is readily detached from and lifted away from the surface 900 by the platform 804, as shown in FIG. 25. In an implementation, the apparatus 800 with at least the platform 804 is a UAV, allowing the apparatus 800 with the crawler 802, detached from the surface 900, to fly away from the surface 900. The steps illustrated in FIGS. 9-14 and as described above are further described below in conjunction with the method 1500 having the steps of the flowchart illustrated in FIG. 15.

In an implementation shown in FIG. 15, a method 1500 is configured to detach a crawler from a surface. The method 1500 includes moving a crawler along a surface of a structure toward a platform, with a magnetic wheel of the crawler magnetically coupled to the surface in step 1502. The method 1500 then engages a first pair of coupling members of the crawler and the platform in a first removable coupling in step 1504, and engages a second pair of coupling members of the crawler and the platform in a second removable coupling in step 1506. The method 1500 then moves the second removable coupling towards the platform using a first actuator in step 1508, and tilts the magnetic wheel using the second removable coupling to reduce the magnetic coupling or adhesion of the magnetic wheel to the surface in step 1510. The method 1500 then moves the first removable coupling toward the platform using a second actuator to move the crawler with the reduced magnetic coupling or adhesion away from the surface in step 1512, and moves the platform removably coupled to the crawler away from the surface in step 1514.

It is to be understood that the steps of detaching the crawler 802 from the surface 900 and attaching the crawler 802 to the platform 804 shown in FIGS. 9-14 are reversible to attach the crawler 802 to the surface 900 and to detach the crawler 802 from the platform 804. That is, the illustrated steps described above, proceeding from the configuration of the apparatus 800 and the surface 900 in FIG. 14 to the configuration of the apparatus 800 and the surface 900 in FIG. 9 are performed to attach the crawler 802 to the surface 900 and to detach the crawler 802 to the platform 804. The reverse progression of the steps illustrated in FIGS. 9-14 and as described above are further described below in conjunction with the method 1600 having the steps of the flowchart illustrated in FIG. 16.

In an implementation shown in FIG. 16, a method 1600 is configured to attach a crawler to a surface, including providing a platform and a crawler with the platform having a first actuator, a second actuator, a first removable coupling, and a second removable coupling, with the platform removably coupled to the crawler by the first and second removable couplings in step 1602. The method 1600 then moves the platform to a position in proximity to a surface of a structure in step 1604, and moves the first removable coupling of the crawler and the platform towards the surface using the second actuator to position a magnetic wheel of the crawler in proximity to the surface in step 1606. The method 1600 then magnetically couples the magnetic wheel to the surface in step 1608, and moves the first actuator to disengage the second removable coupling which couples the crawler to the platform in step 1610. The method 1600 then moves the crawler along the surface in a direction away from the platform to disengage the first removable coupling which couples the platform and the crawler in step 1612.

It is to be understood that like or similar numerals in the drawings represent like or similar elements through the several figures, and that not all components or steps described and illustrated with reference to the figures are required for all embodiments, implementations, or arrangements.

The terminology used herein is for the purpose of describing particular implementations only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary implementations, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to implementations of the disclosure without departing from the essential scope thereof. Therefore, it is intended that the invention not be limited to the particular implementations disclosed, or to the best mode contemplated for carrying out this invention, but that the invention will include all implementations falling within the scope of the appended claims.

The subject matter described above is provided by way of illustration only and should not be construed as limiting. Various modifications and changes can be made to the subject matter described herein without following the example embodiments, implementations, and applications illustrated and described, and without departing from the true spirit and scope of the invention encompassed by the present disclosure, which is defined by the set of recitations in the following claims and by structures and functions or steps which are equivalent to these recitations.

What is claimed is:

1. A crawler configured to move along a surface of a structure, comprising:
a body including:
a first attachment member; and
a pivot point;
a wheel having:
an axle; and
an outer surface having a magnetic component and configured to move adjacent to the surface, wherein the magnetic component establishes a magnetic adhesion of the wheel to the surface; and
a side member coupled to the axle and pivotally coupled to the pivot point, the side member including:
a second attachment member,
wherein, responsive to a device moving the second attachment member, the side member pivots about the pivot point to pivot the axle,
wherein, responsive to the pivoting of the axle, a portion of the outer surface pivots away from the surface, thereby reducing the magnetic adhesion of the wheel to the surface, and
wherein, responsive to the device moving the first attachment member away from the surface, the device overcomes the reduced magnetic adhesion and detaches the wheel from the surface to allow removal of the crawler from the surface.

2. The crawler of claim 1, wherein the first attachment member is configured to removably mechanically couple to the device.

3. The crawler of claim 1, wherein the first attachment member is configured to removably magnetically couple to the device.

4. The crawler of claim 1, wherein the second attachment member is configured to removably mechanically couple to the device.

5. The crawler of claim 4, wherein the second attachment member is configured to slidably engage a slot of the device to removably mechanically couple the second attachment member to the device.

6. The crawler of claim 1, wherein the second attachment member is configured to removably mechanically couple to a hook of the device, and
wherein movement of the hook moves the second attachment member, thereby pivoting the side member about the pivot point to pivot the axle.

7. The crawler of claim 6, wherein the second attachment member includes a slot,
wherein the hook is configured to removably enter the slot, and
wherein the movement of the hook in the slot pivots the side member about the pivot point to pivot the axle.

8. The crawler of claim 6, wherein the device includes an actuator coupled to the hook, and
wherein movement of the actuator moves the hook, thereby moving the second attachment.

9. The crawler of claim 1, wherein the second attachment member is configured to removably magnetically couple to the device.

10. An apparatus, comprising:
a platform including:
a first actuator; and
a second actuator;
a crawler configured to move along a surface of a structure, comprising:
a body including:
a first attachment member removably coupled to the first actuator; and
a pivot point;
a wheel having:
an axle; and
an outer surface having a magnetic component and configured to move adjacent to the surface, wherein the magnetic component establishes a magnetic adhesion of the wheel to the surface; and
a side member coupled to the axle and pivotally coupled to the pivot point, the side member including:
a second attachment member removably coupled to the second actuator,
wherein, responsive to the second actuator moving the second attachment member, the side member pivots about the pivot point to pivot the axle,
wherein, responsive to the pivoting of the axle, a portion of the outer surface pivots away from the surface, thereby reducing the magnetic adhesion of the wheel to the surface, and
wherein, responsive to the first actuator moving the first attachment member away from the surface, the platform overcomes the reduced magnetic adhesion and detaches the wheel from the surface to allow removal of the crawler from the surface.

11. The apparatus of claim 10, wherein the first attachment member is configured to removably mechanically couple to the first actuator.

12. The apparatus of claim 10, wherein the first attachment member is configured to removably magnetically couple to the first actuator.

13. The apparatus of claim 10, wherein the second attachment member is configured to removably mechanically couple to the second actuator.

14. The apparatus of claim 13, wherein the second actuator includes a hook configured to removably mechanically couple to the second actuator, and
wherein movement of the second actuator moves the hook, thereby moving the second attachment member.

15. The apparatus of claim 13, wherein the platform further includes an adaptor having a slot, wherein the platform is coupled to the second actuator,
wherein the second attachment member is configured to slidably engage the slot to removably mechanically couple the second attachment member to the platform.

16. The apparatus of claim 10, wherein the platform further includes an adaptor,
wherein the second attachment member is configured to removably mechanically couple to a hook of the adaptor, and
wherein movement of the hook moves the second attachment member, thereby pivoting the side member about the pivot point to pivot the axle.

17. The apparatus of claim 16, wherein the second attachment member includes a slot,
wherein the hook is configured to removably enter the slot, and
wherein the movement of the hook in the slot pivots the side member about the pivot point to pivot the axle.

18. The apparatus of claim 10, wherein the second attachment member is configured to removably magnetically couple to the device.

19. A method, comprising:
moving a crawler along a surface of a structure, wherein the crawler includes a magnetic wheel magnetically adhering to the surface;
removably engaging a first coupling member of the crawler with a first coupling member of the platform;
removably engaging a second coupling member of the crawler with a second coupling member of the platform;
moving the second coupling member of the crawler towards the platform;
pivoting a magnetic wheel;
moving a portion of the magnetic wheel away from the surface, thereby reducing the magnetic adhesion of the magnetic wheel to the surface;
moving the first coupling member of the platform to move the crawler away from the surface having the reduced magnetic adhesion with the magnetic wheel; and
moving the combination of the crawler and the platform away from the surface.

20. The method of claim 19, wherein moving the second coupling member of the crawler towards the platform includes retracting an actuator coupled to the second coupling member of the crawler.
